(19) United States
(12) Patent Application Publication
(10) Pub. No.: US 2014/0132195 A1
(43) Pub. Date: May 15, 2014

(54) ELECTRIC BOOSTER CONTROL APPARATUS AND METHOD

(71) Applicant: MANDO CORPORATION, Pyeongtaek-si (KR)

(72) Inventor: Kyuwoong CHOI, Yongin-si (KR)

(73) Assignee: MANDO CORPORATION, Pyeongtaek-si, (KR)

(21) Appl. No.: 14/078,018

(22) Filed: Nov. 12, 2013

(30) Foreign Application Priority Data
Nov. 13, 2012 (KR) 10-2012-0127911

(51) Int. Cl. H02P 6/06

(52) U.S. Cl. CPC H02P 6/06
USPC 318/639

(57) ABSTRACT

Disclosed herein are an apparatus and method for control of an electric booster. The apparatus includes a sensing unit to sense information about at least one of displacement and velocity variation of a ball screw, a control unit to receive the information, the control unit including a preset range of reference Wall Pattern position and reference Wall Pattern velocity, a determination unit to determine whether the information is within at least one of the range of reference Wall Pattern position and the range of reference Wall Pattern velocity, and a ball screw initial position setting unit to set a current position of the ball screw contacting a rear wall of the master cylinder to an initial position of the ball screw when it is determined that the information is within the range of reference Wall Pattern position and the range of reference Wall Pattern velocity.

### CROSS-REFERENCE TO RELATED APPLICATION(S)

This application claims the benefit of Korean Patent Application No. 2012-0127911 filed on Nov. 13, 2012 in the Korean Intellectual Property Office, the disclosure of which is incorporated herein by reference.

### BACKGROUND

1. Field

Embodiments of the present invention relate to an apparatus and method for control of an electric booster.

2. Description of the Related Art

A conventional electric booster is generally designed to transfer brake pressure when a driver depresses a pedal and thus a motor moves a ball screw forward to increase the pressure in the master cylinder.

However, in the case of the conventional electric booster, when the ball screw comes into contact with the rear wall of the master cylinder, it may clog the cut-off hole during operation of an electronic stability control (ESC) system, thereby obstructing normal operation of the ESC system.

Accordingly, in recent years, research has been ongoing into an improved apparatus and method for control of the electric booster which may prevent clogging of the cut-off hole by setting the ball screw to an initial position at times when the pedal is not depressed by the driver and thus ensure normal operation of the ESC.

### SUMMARY

Therefore, it is an aspect of the present invention to provide an apparatus and method for control of the electric booster which may set a ball screw for compression of the master cylinder to an initial position and thus prevent clogging of the cut-off hole at times when the pedal is not depressed by the driver, thereby ensuring normal operation of an electronic stability control (ESC) system.

It is another aspect of the present invention to provide an apparatus and method for control of the electric booster which may quickly set a ball screw for compression of the master cylinder to an initial position before the electric booster operates, thereby ensuring quick execution of normal operation of an ESC system.

It is a further aspect of the present invention to provide an apparatus and method for control of the electric booster which may recognize difference between the current position of the ball screw and the initial position and caution the driver against forceful driving for a certain time for which the current position of the ball screw is adjusted to the initial position, thereby reducing the initial-position error rate of the ball screw.

Additional aspects of the invention will be set forth in part in the description which follows and, in part, will be obvious from the description, or may be learned from practice of the invention.

In accordance with one aspect of the present invention, a electric booster control apparatus includes a sensing unit to sense information about at least one of displacement and velocity variation of a ball screw moving to a master cylinder of an electric booster using the Wall Detecting Pattern technique, a control unit to receive the information about at least one of the displacement and velocity variation of the ball screw sensed by the sensing unit, the control unit including a preset range of reference Wall Pattern position and a preset range of reference Wall Pattern velocity, a determination unit to determine, according to control by the control unit, whether the information about at least one of the displacement and velocity variation of the ball screw sensed by the sensing unit is within at least one of the range of reference Wall Pattern position and the range of reference Wall Pattern velocity, and a ball screw initial position setting unit to set, according to control by the control unit, a current position of the ball screw contacting a rear wall of the master cylinder to an initial position of the ball screw when it is determined by the determination unit that the information about at least one of the displacement and velocity variation of the ball screw is within the range of reference Wall Pattern position and the range of reference all Pattern velocity.

The determination unit may receive the information about at least one of the displacement and velocity variation of the ball screw sensed by the sensing unit using the Wall Detecting Pattern technique, and determine, according to control by the control unit, whether the information about at least one of the displacement and velocity variation of the ball screw is within at least one of the range of reference Wall Pattern position and the range of reference Wall Pattern velocity, using an FIR differentiator.

The determination unit may determine, according to control by the control unit, that the ball screw contacts the rear wall of the master cylinder at the current position thereof when the velocity variation of the ball screw according to the displacement of the ball screw changes from a Negative (−) level to Zero (0) level.

The determination unit may determine, according to control by the control unit, that the ball screw contacts the rear wall of the master cylinder at the current position thereof when the velocity variation of the ball screw according to the displacement of the ball screw changes in a pattern of Negative (−)->Negative (−)->Negative (−)->Zero (0)->Zero (0).

The ball screw initial position setting unit may receive a brake pedal signal produced by a brake pedal from an electronic control unit (ECU) before the electric booster operates, and supply, according to control by the ECU, an initial position setting signal for setting of the ball screw to the initial position to the ball screw.

The electric booster control apparatus may further include an indication unit to indicate, when it is determined by the determination unit that the information about at least one of the displacement and velocity variation of the ball screw is within the range of reference Wall Pattern position and the range of reference Wall Pattern velocity, that the ball screw contacts the rear wall of the master cylinder at the current position thereof.

The electric booster control apparatus may further include a display unit to display, when it is determined by the determination unit that the information about at least one of the displacement and velocity variation of the ball screw is within the range of reference Wall Pattern position and the range of reference Wall Pattern velocity, an indication that the ball screw contacts the rear wall of the master cylinder at the current position thereof.

In accordance with another aspect of the present invention, a method of controlling an electric booster includes sensing, through a sensing unit, information about at least one of displacement and velocity variation of a ball screw moving to a master cylinder of the electric booster using the Wall Detecting Pattern technique, determining, through a determination unit according to control by a control unit, whether the information about at least one of the displacement and velocity variation of the ball screw sensed by the sensing unit is within at least one of a range of reference Wall Pattern position and a range of reference Wall Pattern velocity set in the control unit, and setting, through a ball screw initial position setting unit according to control by the control unit, the ball screw contacting a rear wall of the master cylinder at a current position thereof to an initial position thereof when it is determined by the determination unit that the information about at least one of the displacement and velocity variation of the ball screw is within the range of reference Wall Pattern position and the range of reference Wall Pattern velocity.

In the determining, the determination unit may receive the information about at least one of the displacement and velocity variation of the ball screw sensed by the sensing unit using the Wall Detecting Pattern technique, and determines, according to control by the control unit, whether the information about at least one of the displacement and velocity variation of the ball screw is within at least one of the range of reference Wall Pattern position and the range of reference Wall Pattern velocity, using an FIR differentiator.

In the determining, the determination unit may determine, according to control by the control unit, that the ball screw contacts the rear wall of the master cylinder at the current position thereof when the velocity variation of the ball screw according to the displacement of the ball screw changes from a Negative (−) level to Zero (0) level.

In the determining, the determination unit may determine, according to control by the control unit, that the ball screw contacts the rear wall of the master cylinder at the current position thereof when the velocity variation of the ball screw according to the displacement of the ball screw changes in a pattern of Negative (−)->Negative (−)->Negative (−)->Zero (0)->Zero (0).

In the setting of the ball screw to the initial position, the ball screw initial position setting unit may receive a brake pedal signal produced by a brake pedal from an electronic control unit (ECU) before the electric booster operates, and supply, according to control by the ECU, an initial position setting signal for setting of the ball screw to the initial position to the ball screw.

The method may further include indicating, through an indication unit, that the ball screw contacts the rear wall of the master cylinder at the current position thereof when it is determined by the determination unit that the information about at least one of the displacement and velocity variation of the ball screw is within the range of reference Wall Pattern position and the range of reference Wall Pattern velocity, the indicating being performed after the determining.

The method may further include displaying, through a display unit, an indication that the ball screw contacts the rear wall of the master cylinder at the current position thereof when it is determined by the determination unit that the information about at least one of the displacement and velocity variation of the ball screw is within the range of reference Wall Pattern position and the range of reference Wall Pattern velocity, the displaying being performed after the determining.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating connection of an electric booster to an electric booster control apparatus according to a first embodiment of the present invention;

FIG. 2 is a block diagram illustrating an example of the electric booster control apparatus and electric booster shown in FIG. 1;

FIG. 3 is a flowchart illustrating an electric booster control method for the electric booster control apparatus according to the first embodiment;

FIG. 4 is a flowchart illustrating an example of the electric booster control method for the electric booster control apparatus according to the first embodiment;

FIG. 5 is a flowchart illustrating another example of the electric booster control method for the electric booster control apparatus according to the first embodiment;

FIG. 6 is a block diagram illustrating connection of an electric booster to an electric booster control apparatus according to a second embodiment of the present invention;

FIG. 7 is a block diagram illustrating an example of the electric booster control apparatus and electric booster shown in FIG. 6;

FIG. 8 is a flowchart illustrating an electric booster control method for the electric booster control apparatus according to the second embodiment;

FIG. 9 is a flowchart illustrating an example of the electric booster control method for the electric booster control apparatus according to the second embodiment.

FIG. 10 is a flowchart illustrating another example of the electric booster control method for the electric booster control apparatus according to the second embodiment;

FIG. 11 is a block diagram illustrating an example of an electric booster and an electric booster control apparatus according to a third embodiment of the present invention;

FIG. 12 is a flowchart illustrating an electric booster control method for the electric booster control apparatus according to the third embodiment;

FIG. 13 is a flowchart illustrating an example of the electric booster control method for the electric booster control apparatus according to the third embodiment;

FIG. 14 is a flowchart illustrating another example of the electric booster control method for the electric booster control apparatus according to the third embodiment;

FIG. 15 is a block diagram illustrating an example of an electric booster and an electric booster control apparatus according to a fourth embodiment of the present invention;

FIG. 16 is a flowchart illustrating an electric booster control method for the electric booster control apparatus according to the fourth embodiment;

FIG. 17 is a flowchart illustrating an example of the electric booster control method for the electric booster control apparatus according to the fourth embodiment; and

FIG. 18 is a flowchart illustrating another example of the electric booster control method for the electric booster control apparatus according to the fourth embodiment.

### DETAILED DESCRIPTION

Reference will now be made in detail to the embodiments of the present invention, examples of which are illustrated in the accompanying drawings, wherein like reference numerals refer to like elements throughout.

### First Embodiment

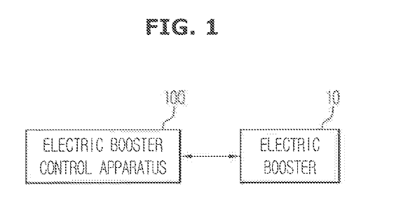

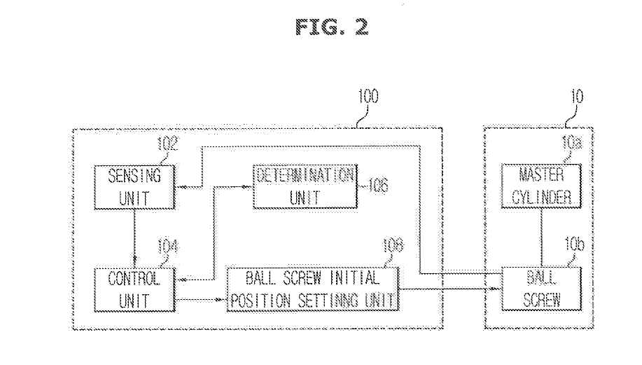

FIG. 1 is a block diagram illustrating connection of an electric booster to an electric booster control apparatus according to a first embodiment of the present invention, and FIG. 2 is a block diagram illustrating an example of the electric booster control apparatus and electric booster shown in FIG. 1.

Referring to FIGS. 1 and 2, the electric booster control apparatus 100 according to the first embodiment includes a sensing unit 102, a control unit 104, a determination unit 106, and a ball screw initial position setting unit 108.

The sensing unit 102 senses information about at least one of the displacement and velocity variation of a ball screw 10b moving to a master cylinder 10a of an electric booster 10, using the Wall Detecting Pattern technique.

Although not shown in FIGS. 1 and 2, the sensing unit 102 may be an encoder (not shown) to estimate position or a position detecting sensor (not shown), or may be a tachometer (not shown) to estimate speed or a speed detecting sensor (not shown).

The control unit 104 receives the information about at least one of the displacement and velocity variation of the ball screw 10b sensed by the sensing unit 102, and includes predetermined ranges of reference Wall Pattern position and reference Wall Pattern velocity.

Although not shown in FIGS. 1 and 2, the control unit 104 may include an electronic control unit (ECU) or a microcontroller (MCU).

The determination unit 106 determines whether the information about at least one of the displacement and velocity variation of the ball screw 10b sensed by the sensing unit 102 is within at least one of the range of reference Wall Pattern position and the range of reference Wall Pattern velocity, according to control by the control unit 104.

For example, the determination unit 106 may receive the information about at least one of the displacement and velocity variation of the ball screw 10b sensed by the sensing unit 102 with the Wall Detecting Pattern technique and determine, according to control by the control unit 104, whether the information about at least one of the displacement and velocity variation of the ball screw 10b is within at least one of the range of reference Wall Pattern position and the range of reference Wall Pattern velocity using an FIR differentiator (not shown).

Herein, when the Wall Detecting Pattern technique is used, the velocity variation of the ball screw 10b may be sensed according to Equation 1 given below.

v[n−4]<0, v[n−3]<0, v[n−2]<0, v[n−1]=0, v[n]=0. Equation 1

Herein, v[*] denotes velocity of the ball screw 10b. v[n−4], v[n−3], v[n−2], and v[n−1] are values of previous velocities, and v[n] is a value of the current velocity.

In addition, when the FIR Differentiator (not shown) is used, the displacement of the ball screw 10b may be sensed according to Equation 2 given below.

v[n]=x[n−6]+1.5*x[n−5]+3*x[n−4]+3*x[n−2]+1.5*x[n−1]+x[n] Equation 2

Herein, x[n−6], x[n−5], x[n−4], x[n−2], and x[n−1] are values of previous positions of the ball screw 10b, and x[n] is a value of the current position of the ball screw 10b.

When the velocity variation of the ball screw 10b changes from a negative (−) level to the zero (0) level according to a displacement of the ball screw 10b, the determination unit 106 may determine, according to control by the control unit 104, that the ball screw 10b contacts the rear wall of the master cylinder 10a at the current position.

For example, when the velocity variation of the ball screw 10b according to the displacement of the ball screw 10b changes in the pattern of Negative (−)->Negative (−)->Negative (−)->Zero (0)->Zero (0), the determination unit 106 may determine, according to control by the control unit 104, that the ball screw 10b contacts the rear wall of the master cylinder 10a at the current position.

When the information about at least one of the displacement and velocity variation of the ball screw 10b is within the range of reference Wall Pattern position and the range of reference Wall Pattern velocity, the ball screw initial position setting unit 108 may set, according to control by the control unit 104, the ball screw 10b contacting the rear wall of the master cylinder 10a to the initial position.

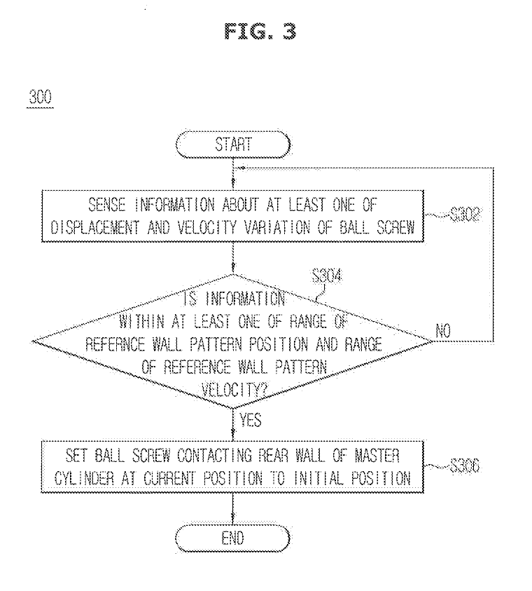

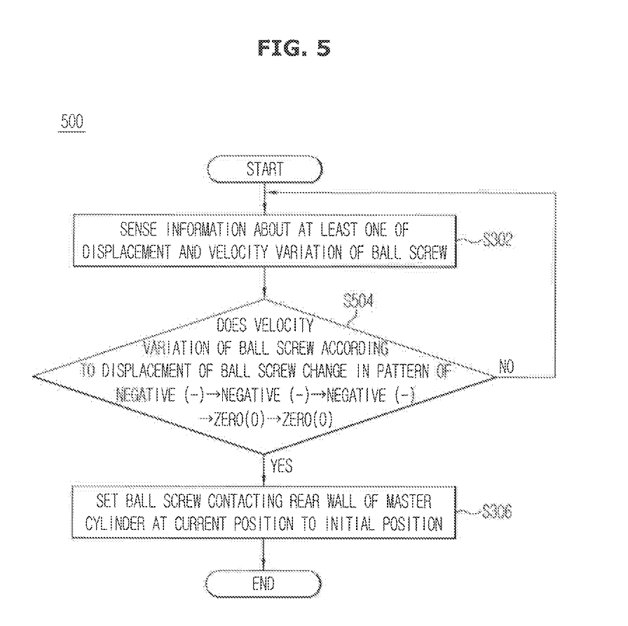

Hereinafter, a description will be given of a method of controlling the electric booster using an electric booster control apparatus according to the first embodiment with reference to FIGS. 3 and 5.

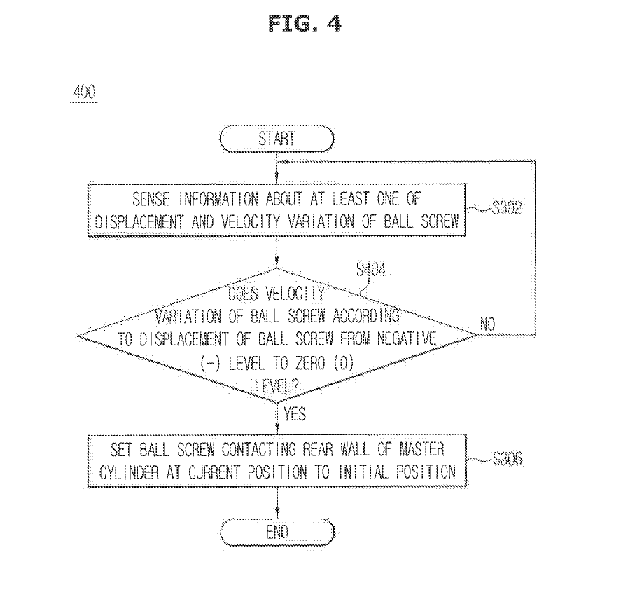

FIG. 3 is a flowchart illustrating an electric booster control method for the electric booster control apparatus according to the first embodiment, and FIG. 4 is a flowchart illustrating an example of the electric booster control method for the electric booster control apparatus according to the first embodiment.

FIG. 5 is a flowchart illustrating another example of the electric booster control method for the electric booster control apparatus according to the first embodiment.

Referring to FIGS. 3 and 5, the electric booster control method 300, 400 and 500 for the electric booster control apparatus 100 according to the first embodiment includes operations of sensing (S302), determination (S304, S404 and S504), and ball screw initial position setting (S306).

First, in the sensing operation (S302), a sensing unit (see 102 in FIG. 2) senses information about at least one of the displacement and velocity variation of a ball screw 10b moving to a master cylinder (see 10a in FIG. 2) of an electric booster (see 10 in FIGS. 1 and 2), using the Wall Detecting Pattern technique.

Thereafter, in the determination operation (S304, S404 and S504), the determination unit (see 106 in FIG. 2) determines whether the information about at least one of the displacement and velocity variation of the ball screw (see 10b in FIG. 2) sensed by the sensing unit (see 102 in FIG. 2) is within at least one of the range of reference Wall Pattern position and the range of reference Wall Pattern velocity, according control by the control unit (see 104 in FIG. 2).

In the determination operation (S304, S404 and S504), the determination unit (see 106 in FIG. 2) may receive the information about at least one of the displacement and velocity variation of the ball screw (see 10b in FIG. 2) sensed by the sensing unit (see 102 in FIG. 2) with the Wall Detecting Pattern technique, and determine, according to control by the control unit (see 104 in FIG. 2), whether the information about at least one of the displacement and velocity variation of the ball screw (see 10b in FIG. 2) is within at least one of the range of reference Wall Pattern position and the range of reference Wall Pattern velocity using an FIR differentiator (not shown).

For example, in the determination operation (S404) as shown in FIG. 4, when the velocity variation of the ball screw (see 10b in FIG. 2) changes from a negative (−) level to zero (0) level according to a displacement of the ball screw (see 10b in FIG. 2), the determination unit (see 106 in FIG. 2) may determine, according to control by the control unit (see 104 in FIG. 2), that the ball screw (see 10b in FIG. 2) contacts the rear wall of the master cylinder (see 10a in FIG. 2) at the current position.

In another example, in the determination operation (S504) as shown in FIG. 5, when the velocity variation of the ball screw (see 10b in FIG. 2) according to the displacement of the ball screw (see 10b in FIG. 2) changes in the pattern of Negative (−)->Negative (−)->Negative (−)->Zero (0)->Zero (0), the determination unit (see 106 in FIG. 2) may determine, according to control by the control unit (see 104 in FIG. 2), that the ball screw (see 10b in FIG. 2) contacts the rear wall of the master cylinder (see 10a in FIG. 2) at the current position.

Finally, in the ball screw initial position setting operation (S306), when the information about at least one of the displacement and velocity variation of the ball screw (see 10b in FIG. 2) determined by the determination unit (see 106 in FIG. 2) is within the range of reference Wall Pattern position and the range of reference Wall Pattern velocity, the ball screw initial position setting unit (see 108 in FIG. 2) may set, according to control by the control unit (see 104 in FIG. 2), the current position of the ball screw (see 10b in FIG. 2) contacting the rear wall of the master cylinder (see 10a in FIG. 2) to the initial position.

As discussed above, in the electric booster control method (300, 400 and 500) for the electric booster control apparatus 100 according to the first embodiment of the present invention, the sensing operation (S302), the determination operation (S304, S404 and S504), and the ball screw initial position setting operation (S306) are performed using the sensing unit 102, the control unit 104, the determination unit 106, and the ball screw initial position setting unit 108.

Accordingly, in the electric booster control method 300, 400 and 500 for the electric booster control apparatus 100, the ball screw 10b to compress the master cylinder 10a may be set to an initial position. Accordingly, clogging of the cut-off hole may be prevented at times when the pedal is not depressed by the driver, and therefore normal operation of the electronic stability control (ESC) system may be ensured.

### Second Embodiment

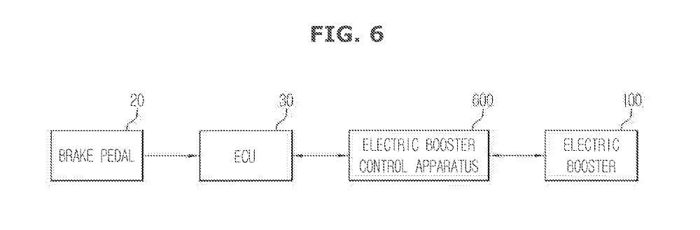

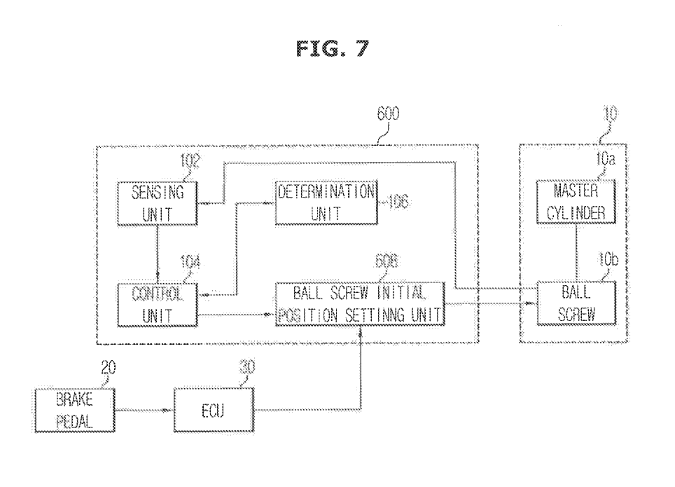

FIG. 6 is a block diagram illustrating connection of an electric booster to an electric booster control apparatus according to a second embodiment of the present invention, and FIG. 7 is a block diagram illustrating an example of the electric booster control apparatus and electric booster shown in FIG. 6.

Referring to FIGS. 6 and 7, the electric booster control apparatus 600 according to the second embodiment includes a sensing unit 102, a control unit 104, a determination unit 106, and a ball screw initial position setting unit 608, which are identical to those of the electric booster control apparatus 100 according to the first embodiment.

Functions of constituents of the electric booster control apparatus 600 and an organic connection between the constituents are the same as those of the electric booster control apparatus 100 according to the first embodiment, and therefore a detailed description thereof will be omitted.

The ball screw initial position setting unit 608 of the electric booster control apparatus 600 receives, from an electronic control unit (ECU) 30, a brake pedal signal produced by a brake pedal 20 before the electric booster 10 operates, and then supplies, according to control by the ECU 30, an initial position setting signal for setting of the ball screw 10b to the initial position to the ball screw 10b.

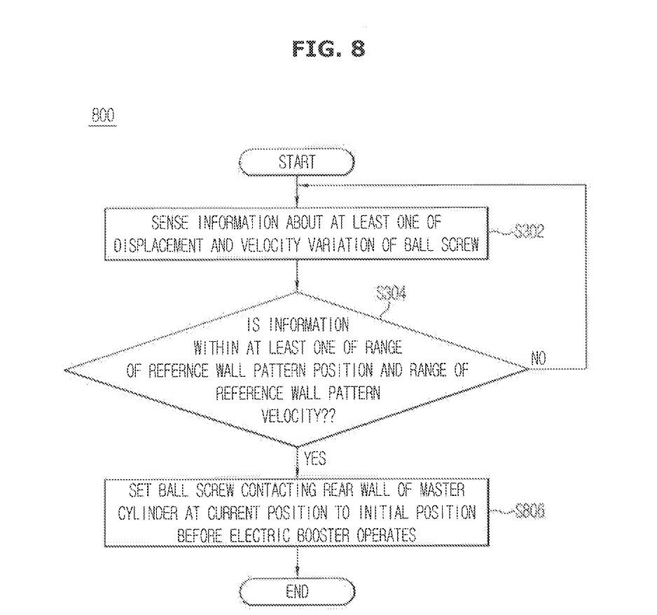

A method of controlling the electric booster 10 using the electric booster control apparatus 600 is illustrated in FIGS. 8 to 10.

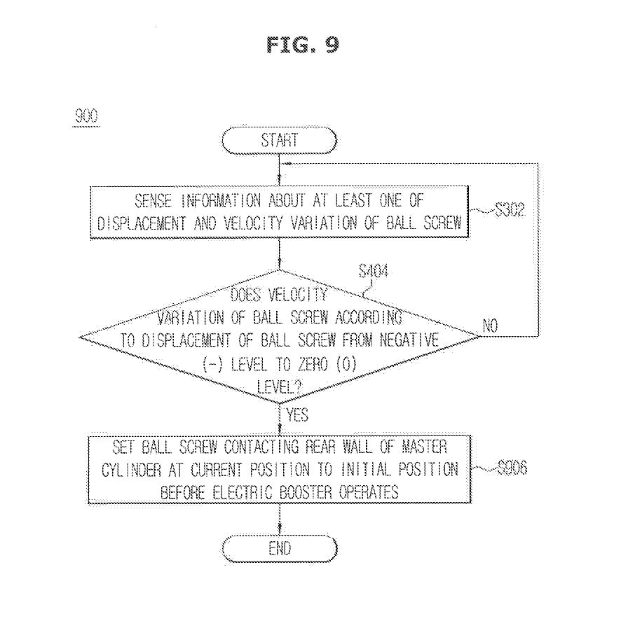

FIG. 8 is a flowchart illustrating an electric booster control method for the electric booster control apparatus according to the second embodiment, and FIG. 9 is a flowchart illustrating an example of the electric booster control method for the electric booster control apparatus according to the second embodiment.

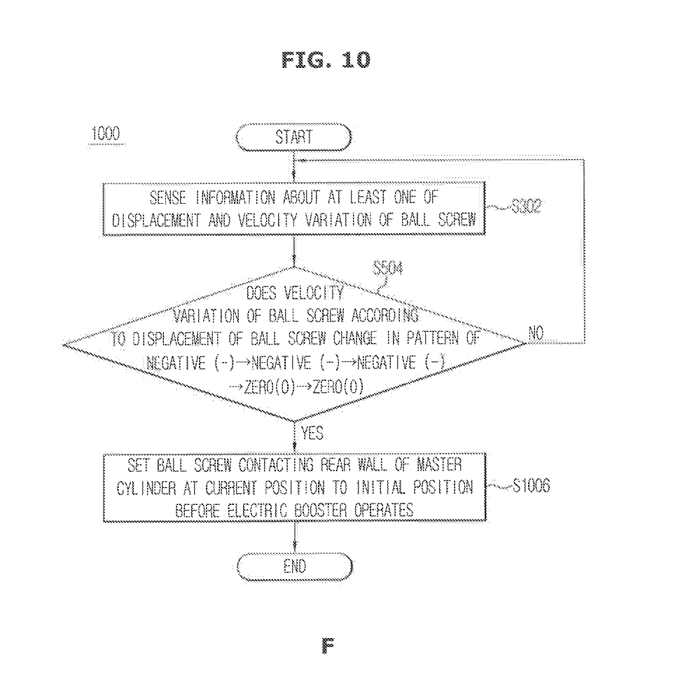

FIG. 10 is a flowchart illustrating another example of the electric booster control method for the electric booster control apparatus according to the second embodiment.

Referring to FIGS. 8 to 10, the electric booster control method 800, 900 and 1000 for the electric booster control apparatus 600 according to the second embodiment includes operations of sensing (S302) and determination (S304, S404 and S504), which are identical to those of the electric booster control method 300, 400 and 500 for the electric booster control apparatus 100 according to the first embodiment.

Functions of the operations of the electric booster control method 800, 900 and 1000 for the electric booster control apparatus 600 and an organic connection between the operations are the same as those of the electric booster control method 300, 400 and 500 for the electric booster control apparatus 100, and therefore a detailed description thereof will be omitted.

In the electric booster control method 800, 900 and 1000 for the electric booster control apparatus 600, the ball screw initial position setting operation (S806, S906, S1006) is performed after the determination operation (S304, S404, S504).

That is, in the ball screw initial position setting operation (S806, S906, S1006), when the information about at least one of the displacement and velocity variation of the ball screw (see 10b in FIG. 7) determined by the determination unit (see 106 in FIG. 7) is within the range of reference Wall Pattern position and the range of reference Wall Pattern velocity, the ball screw initial position setting unit (see 108 in FIG. 2) may set, according to control by the control unit (see 104 in FIG. 7), the current position of the ball screw (see 10b in FIG. 7) contacting the rear wall of the master cylinder (see 10a in FIG. 2) to the initial position.

At this time, in the ball screw initial position setting operation (S806, S906, S1006), the ball screw initial position setting unit (see 608 FIG. 7) receives, from the ECU (see 30 in FIGS. 6 and 7), a brake pedal signal produced by the brake pedal (see 20 in FIGS. 6 and 7) before the electric booster (see 10 in FIGS. 6 and 7) operates, and then supplies, according to control by the ECU (see 30 in FIGS. 6 and 7), an initial position setting signal for setting of the ball screw (see 10b in FIG. 7) to the initial position to the ball screw (see 10b in FIG. 7).

As discussed above, in the electric booster control method 800, 900 and 1000 for the electric booster control apparatus 600 according to the second embodiment of the present invention, the sensing operation (S302), the determination operation (S304, S404 and S504), and the ball screw initial position setting operation (S806, S906 and S1006) are performed using the sensing unit 102, the control unit 104, the determination unit 106, and the ball screw initial position setting unit 108.

Accordingly, in the electric booster control method 800, 900 and 1000 for the electric booster control apparatus 600 according to the second embodiment, the ball screw 10b to compress the master cylinder 10a may be quickly set to the initial position before the electric booster 10 operate, and therefore normal operation of the ESC system may be quickly performed.

### Third Embodiment

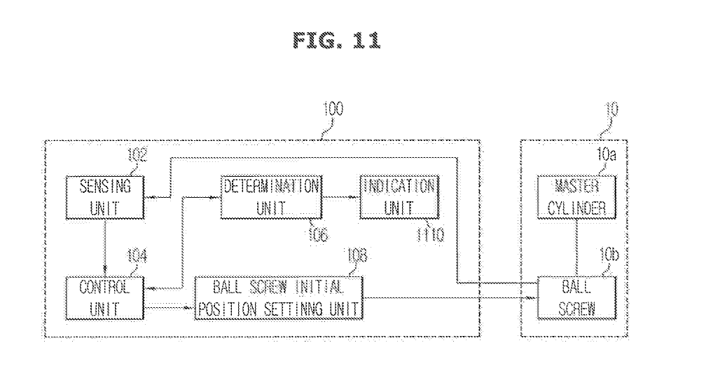

FIG. 11 is a block diagram illustrating an example of an electric booster and an electric booster control apparatus according to a third embodiment of the present invention.

Referring to FIG. 11, the electric booster control apparatus 1100 according to the third embodiment includes a sensing unit 102, a control unit 104, a determination unit 106, and a ball screw initial position setting unit 108, which are the identical to those of the electric booster control apparatus 100 according to the first embodiment.

Functions of constituents of the electric booster control apparatus 1100 and an organic connection between the constituents are the same as those of the electric booster control apparatus 100 according to the first embodiment, and therefore a detailed description thereof will be omitted.

The electric booster control apparatus 1100 according to the third embodiment further includes the indication unit 1110.

That is, when the information about at least one of the displacement and velocity variation of the ball screw 10b determined by the determination unit 106 is within the range of reference Wall Pattern position and the range of reference Wall Pattern velocity, the indication unit 1110 indicates that the ball screw 10b contacts the rear wall of the master cylinder 10a at the current position.

Herein, the indication unit 1110 includes at least one of a speaker (not shown) and a light emitting member (not shown). Thereby, through the sound-making operation of the speaker (not shown) and the light-emitting operation of the light emitting member (not shown), the indication unit 1110 indicates that the ball screw 10b contacts the rear wall of the master cylinder 10a at the current position.

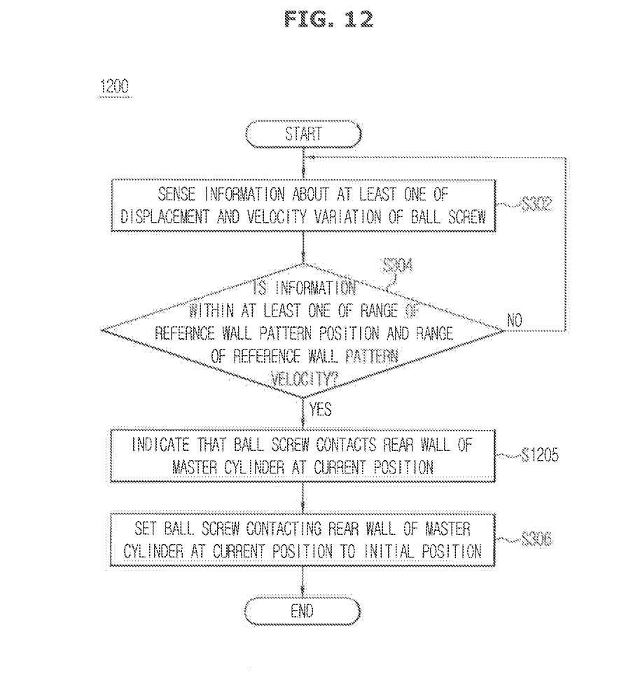

A method of controlling the electric booster 10 using the electric booster control apparatus 1100 is illustrated in FIGS. 12 to 14.

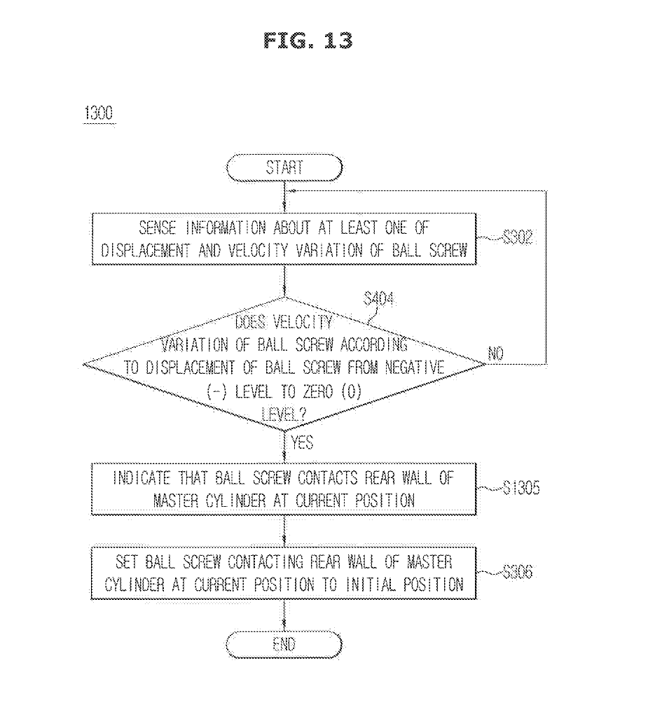

FIG. 12 is a flowchart illustrating an electric booster control method for the electric booster control apparatus according to the third embodiment, and FIG. 13 is a flowchart illustrating an example of the electric booster control method for the electric booster control apparatus according to the third embodiment.

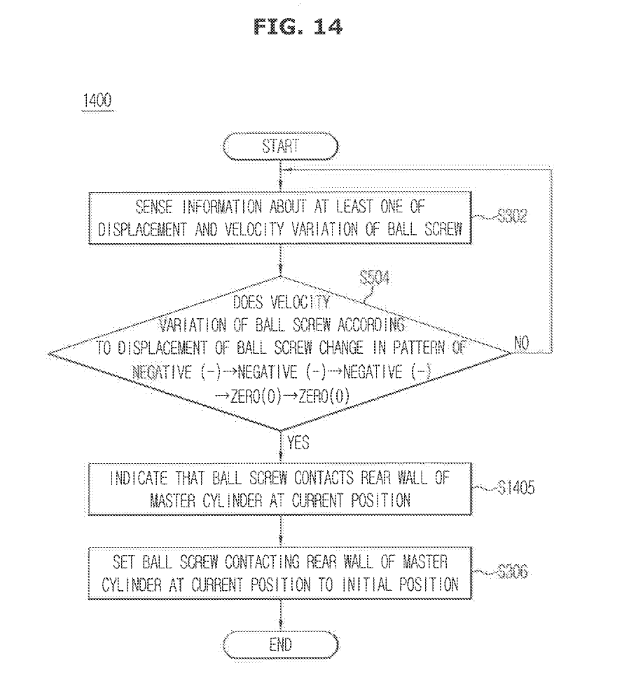

FIG. 14 is a flowchart illustrating another example of the electric booster control method for the electric booster control apparatus according to the third embodiment.

Referring to FIGS. 12 to 14, the electric booster control method 1200, 1300 and 1400 for the electric booster control apparatus 1100 according to the third embodiment includes operations of sensing (S302) and determination (S304, S404 and S504), and ball screw initial position setting (S306), which are identical to those of the electric booster control method 300, 400 and 500 for the electric booster control apparatus 100 according to the first embodiment.

Functions of the operations of the electric booster control method 1200, 1300 and 1400 for the electric booster control apparatus 1100 and an organic connection between the operations are the same as those of the electric booster control method 300, 400 and 500 for the electric booster control apparatus 100, and therefore a detailed description thereof will be omitted.

In the electric booster control method 1200, 1300 and 1400 for the electric booster control apparatus 1100, the indication operation (S1205, S1305 and S1405) is performed after the determination operation (S304, S404 and S504) and before the ball screw initial position setting operation (S306).

That is, in the indication operation (S1205, S1305 and S1405), when the information about at least one of the displacement and velocity variation of the ball screw (see 10b in FIG. 11) determined by the determination unit (see 106 in FIG. 11) is within the range of reference Wall Pattern position and the range of reference Wall Pattern velocity, the indication unit (see 1110 in FIG. 11) indicates that the ball screw (see 10b in FIG. 11) contacts the rear wall of the master cylinder (see 10a in FIG. 11) at the current position.

As discussed above, in the electric booster control method 1200, 1300 and 1400 for the electric booster control apparatus 1100, the sensing operation (S302), the determination operation (S304, S404, S504), the indication operation (S1205, S1305 and S1405) and the ball screw initial position setting operation (S306) are performed using the sensing unit 102, the control unit 104, the determination unit 106, the ball screw initial position setting unit 108, and the indication unit 1110.

Accordingly, in the electric booster control method 1200, 1300 and 1400 for the electric booster control apparatus 1100, the ball screw 10b to compress the master cylinder 10a may be set to the initial position. Therefore, clogging of the cut-off hole may be prevented at times when the pedal is not depressed by the driver, and thereby normal operation of the ESC system may be ensured.

In addition, in the electric booster control method 1200, 1300 and 1400 for the electric booster control apparatus 1100, the indication unit 1110 may indicate that the ball screw 10b contacts the rear wall of the master cylinder 10a at the current position of the ball screw 10b.

Accordingly, the electric booster control method 1200, 1300 and 1400 for the electric booster control apparatus 1100 allows recognizing that the current position of the ball screw 10b is not the initial position. Therefore, the driver may be cautioned against forceful driving for a certain time for which the current position of the ball screw is adjusted to the initial position, and thereby the initial-position error rate of the ball screw may be reduced.

### Fourth Embodiment

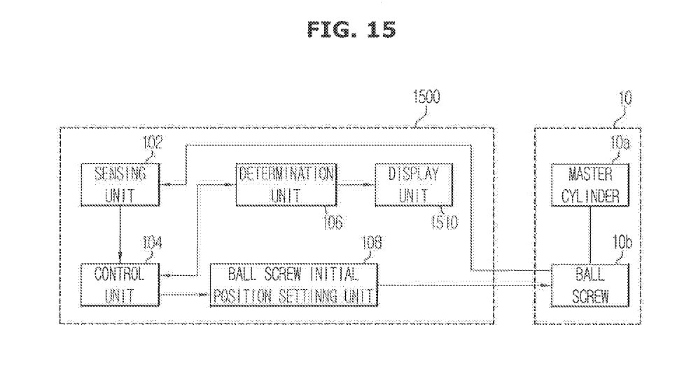

FIG. 15 is a block diagram illustrating an example of an electric booster and an electric booster control apparatus according to a fourth embodiment of the present invention.

Referring to FIG. 15, the electric booster control apparatus 1500 according to the fourth embodiment includes a sensing unit 102, a control unit 104, a determination unit 106, and a ball screw initial position setting unit 108, which are identical to those of the electric booster control apparatus 100 according to the first embodiment.

Functions of constituents of the electric booster control apparatus 1500 and an organic connection between the constituents are the same as those of the electric booster control apparatus 100 according to the first embodiment, and therefore a detailed description thereof will be omitted.

The electric booster control apparatus 1500 further includes a display unit 1510.

That is, when the information about at least one of the displacement and velocity variation of the ball screw 10b determined by the determination unit 106 is within the range of reference Wall Pattern position and the range of reference Wall Pattern velocity, the display unit 1510 displays an indication that the ball screw 10b contacts the rear wall of the master cylinder 10a at the current position.

Herein, the display unit 1510 may include a Human Machine Interface (HMI) module (not shown). Thereby, the display unit 1510 may display an HMI message indicating that the ball screw 10b contacts the rear wall of the master cylinder 10a at the current position.

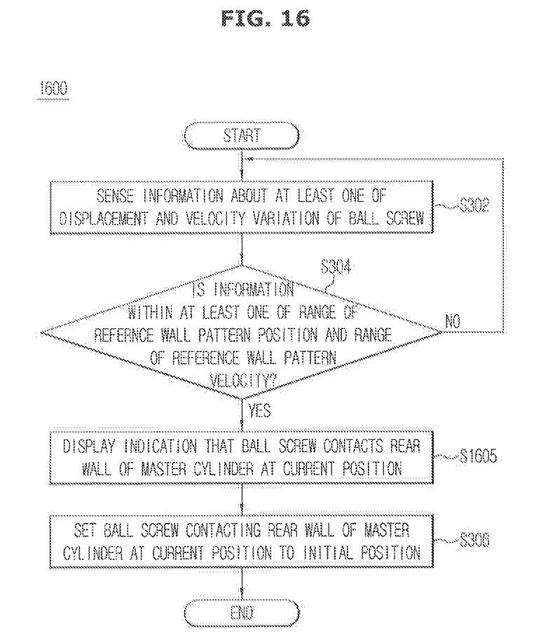

A method of controlling the electric booster 10 using the electric booster control apparatus 1500 is illustrated in FIGS. 16 to 18.

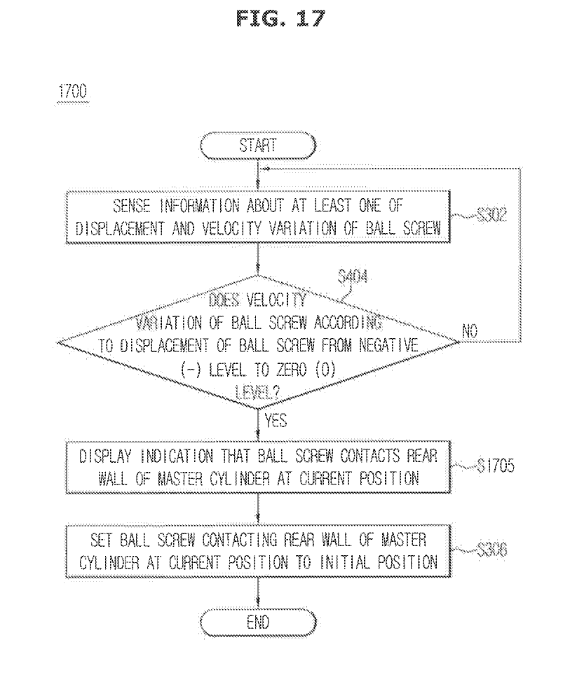

FIG. 16 is a flowchart illustrating an electric booster control method for the electric booster control apparatus according to the fourth embodiment, and FIG. 17 is a flowchart illustrating an example of the electric booster control method for the electric booster control apparatus according to the fourth embodiment.

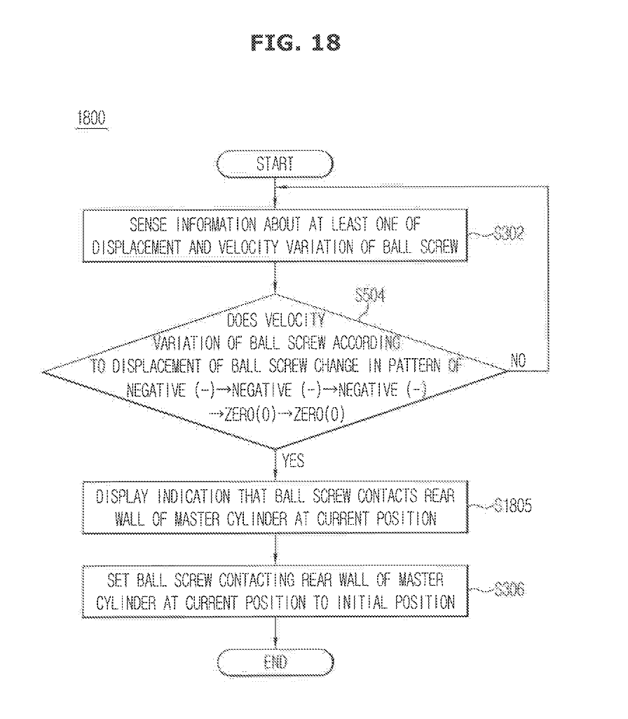

FIG. 18 is a flowchart illustrating another example of the electric booster control method for the electric booster control apparatus according to the fourth embodiment.

Referring to FIGS. 16 to 18, the electric booster control method 1600, 1700 and 1800 for the electric booster control apparatus 1500 according to the fourth embodiment includes operations of sensing (S302) and determination (S304, S404 and S504), and ball screw initial position setting (S306), which are identical to those of the electric booster control method 300, 400 and 500 for the electric booster control apparatus 100 according to the first embodiment.

Functions of the operations of the electric booster control method 1600, 1700 and 1800 for the electric booster control apparatus 1500 and an organic connection between the operations are the same as those of the electric booster control method 300, 400 and 500 for the electric booster control apparatus 100, and therefore a detailed description thereof will be omitted.

In the electric booster control method 1600, 1700 and 1800 for the electric booster control apparatus 1500, the displaying operation (S1605, S1705 and S1805) is performed after the determination operation (S304, S404 and S504) and before the ball screw initial position setting operation (S306).

That is, in the displaying operation (S1605, S1705 and S1805), when the information about at least one of the displacement and velocity variation of the ball screw (see 10b in FIG. 15) determined by the determination unit (see 106 in FIG. 15) is within the range of reference Wall Pattern position and the range of reference Wall Pattern velocity, the display unit (see 1510 in FIG. 15) displays an indication that the ball screw (see 10b in FIG. 15) contacts the rear wall of the master cylinder (see 10a in FIG. 15) at the current position.

As discussed above, in the electric booster control method 1600, 1700 and 1800 for the electric booster control apparatus 1500, the sensing operation (S302), the determination operation (S304, S404 and S504), the displaying operation (S1605, S1705 and S1805), and the ball screw initial position setting operation (S306) are performed using the sensing unit 102, the control unit 104, the determination unit 106, the ball screw initial position setting unit 108, the display unit 1510.

Accordingly, in the electric booster control method 1600, 1700 and 1800 for the electric booster control apparatus 1500, the ball screw 10b to compress the master cylinder 10a may be set to the initial position. Therefore, clogging of the cut-off hole may be prevented at times when the pedal is not depressed by the driver, and thereby normal operation of the ESC system may be ensured.

In addition, the electric booster control method 1600, 1700 and 1800 for the electric booster control apparatus 1500 allows the display unit 1510 to display an indication that the ball screw 10b contacts the rear wall of the master cylinder 10a at the current position.

Accordingly, the electric booster control method 1600, 1700 and 1800 for the electric booster control apparatus 1500 allows recognizing that the current position of the ball screw 10b is not the initial position. Therefore, the driver may be cautioned against forceful driving for a certain time for which the current position of the ball screw is adjusted to the initial position, and thereby the initial-position error rate of the ball screw may be further reduced.

As is apparent from the above description, an apparatus and a method for control of an electric booster according to embodiments of the present invention have the following effects.

First, a ball screw for compression of the master cylinder is allowed to be set to an initial position. Therefore, clogging of the cut-off hole may be prevented at times when the pedal is not depressed by the driver. Thereby, normal operation of an electronic stability control (ESC) system may be ensured.

Second, the ball screw for compression of the master cylinder may be quickly set to the initial position thereof before the electric booster operates. Therefore, normal operation of the ESC system may be quickly performed.

Finally, it may be possible to recognize that the current position of the ball screw is not the initial position. Therefore, the driver may be cautioned against forceful driving for a certain time for which the current position of the ball screw is adjusted to the initial position. Thereby, the initial-position error rate of the ball screw may be greatly reduced.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A electric booster control apparatus comprising:
a sensing unit to sense information about at least one of displacement and velocity variation of a ball screw moving to a master cylinder of an electric booster using the Wall Detecting Pattern technique;
a control unit to receive the information about at least one of the displacement and velocity variation of the ball screw sensed by the sensing unit, the control unit including a preset range of reference Wall Pattern position and a preset range of reference Wall Pattern velocity;
a determination unit to determine, according to control by the control unit, whether the information about at least one of the displacement and velocity variation of the ball screw sensed by the sensing unit is within at least one of the range of reference Wall Pattern position and the range of reference Wall Pattern velocity; and
a ball screw initial position setting unit to set, according to control by the control unit, a current position of the ball screw contacting a rear wall of the master cylinder to an initial position of the ball screw when it is determined by the determination unit that the information about at least one of the displacement and velocity variation of the ball screw is within the range of reference Wall Pattern position and the range of reference Wall Pattern velocity.

2. The electric booster control apparatus according to claim 1, wherein the determination unit receives the information about at least one of the displacement and velocity variation of the ball screw sensed by the sensing unit using the Wall Detecting Pattern technique, and determines, according to control by the control unit, whether the information about at least one of the displacement and velocity variation of the ball screw is within at least one of the range of reference Wall Pattern position and the range of reference Wall Pattern velocity, using an FIR differentiator.

3. The electric booster control apparatus according to claim 2, wherein the determination unit determines, according to control by the control unit, that the ball screw contacts the rear wall of the master cylinder at the current position thereof when the velocity variation of the ball screw according to the displacement of the ball screw changes from a Negative (−) level to Zero (0) level.

4. The electric booster control apparatus according to claim 3, wherein the determination unit determines, according to control by the control unit, that the ball screw contacts the rear wall of the master cylinder at the current position thereof when the velocity variation of the ball screw according to the displacement of the ball screw changes in a pattern of Negative (−)->Negative (−)->Negative (−)->Zero (0)->Zero (0).

5. The electric booster control apparatus according to claim 1, wherein the ball screw initial position setting unit receives a brake pedal signal produced by a brake pedal from an electronic control unit (ECU) before the electric booster operates, and supplies, according to control by the ECU, an initial position setting signal for setting of the ball screw to the initial position to the ball screw.

6. The electric booster control apparatus according to claim 1, further comprising an indication unit to indicate, when it is determined by the determination unit that the information about at least one of the displacement and velocity variation of the ball screw is within the range of reference Wall Pattern position and the range of reference Wall Pattern velocity, that the ball screw contacts the rear wall of the master cylinder at the current position thereof.

7. The electric booster control apparatus according to claim 1, further comprising a display unit to display, when it is determined by the determination unit that the information about at least one of the displacement and velocity variation of the ball screw is within the range of reference Wall Pattern position and the range of reference Wall Pattern velocity, an indication that the ball screw contacts the rear wall of the master cylinder at the current position thereof.

8. A method of controlling an electric booster comprising:
sensing, through a sensing unit, information about at least one of displacement and velocity variation of a ball screw moving to a master cylinder of the electric booster using the Wall Detecting Pattern technique;
determining, through a determination unit according to control by a control unit, whether the information about at least one of the displacement and velocity variation of the ball screw sensed by the sensing unit is within at least one of a range of reference Wall Pattern position and a range of reference Wall Pattern velocity set in the control unit; and
setting, through a ball screw initial position setting unit according to control by the control unit, the ball screw contacting a rear wall of the master cylinder at a current position thereof to an initial position thereof when it is determined by the determination unit that the information about at least one of the displacement and velocity variation of the ball screw is within the range of reference Wall Pattern position and the range of reference Wall Pattern velocity.

9. The method according to claim 8, wherein, in the determining, the determination unit receives the information about at least one of the displacement and velocity variation of the ball screw sensed by the sensing unit using the Wall Detecting Pattern technique, and determines, according to control by the control unit, whether the information about at least one of the displacement and velocity variation of the ball screw is within at least one of the range of reference Wall Pattern position and the range of reference Wall Pattern velocity, using an FIR differentiator.

10. The method according to claim 9, wherein, in the determining, the determination unit determines, according to control by the control unit, that the ball screw contacts the rear wall of the master cylinder at the current position thereof when the velocity variation of the ball screw according to the displacement of the ball screw changes from a Negative (−) level to Zero (0) level.

11. The method according to claim 10, wherein, in the determining, the determination unit determines, according to control by the control unit, that the ball screw contacts the rear wall of the master cylinder at the current position thereof when the velocity variation of the ball screw according to the displacement of the ball screw changes in a pattern of Negative (−)->Negative (−)->Negative (−)->Zero (0)->Zero (0).

12. The method according to claim 8, wherein, in the setting of the ball screw to the initial position, the ball screw initial position setting unit receives a brake pedal signal produced by a brake pedal from an electronic control unit (ECU) before the electric booster operates, and supplies, according to control by the ECU, an initial position setting signal for setting of the ball screw to the initial position to the ball screw.

13. The method according to claim 8, further comprising indicating, through an indication unit, that the ball screw contacts the rear wall of the master cylinder at the current position thereof when it is determined by the determination unit that the information about at least one of the displacement and velocity variation of the ball screw is within the range of reference Wall Pattern position and the range of reference Wall Pattern velocity, the indicating being performed after the determining.

14. The method according to claim 8, further comprising displaying, through a display unit, an indication that the ball screw contacts the rear wall of the master cylinder at the current position thereof when it is determined by the determination unit that the information about at least one of the displacement and velocity variation of the ball screw is within the range of reference Wall Pattern position and the range of reference Wall Pattern velocity, the displaying being performed after the determining.
